(19) United States
(12) Patent Application Publication
(10) Pub. No.: US 2025/0264770 A1
(43) Pub. Date: Aug. 21, 2025

(54) DISPLAY SUBSTRATE AND DISPLAY DEVICE WITH SUPPRESSED OCCURRENCE OF DISPLAY UNEVENNESS

(71) Applicant: Sharp Display Technology Corporation, Kameyama City (JP)

(72) Inventor: Hidehiko SUZUKI, Kameyama City (JP)

(21) Appl. No.: 19/011,922

(22) Filed: Jan. 7, 2025

(30) Foreign Application Priority Data
Feb. 20, 2024 (JP) 2024-023509

(51) Int. Cl. G02F 1/1362; G02F 1/1368

(52) U.S. Cl. CPC G02F 1/136286; G02F 1/1368

(57) ABSTRACT

A display substrate includes a first wiring line, a first switching element connected to the first wiring line, a second switching element connected to the first wiring line, a second wiring line overlapping the first wiring line, a first electrode connected to the first switching element, a second electrode connected to the second switching element, and a third electrode overlapping the first electrode and the second electrode.

### CROSS-REFERENCE TO RELATED APPLICATIONS

This application claims the benefit of priority to Japanese Patent Application Number 2024-023509 filed on Feb. 20, 2024. The entire contents of the above-identified application are hereby incorporated by reference.

### BACKGROUND

### Technical Field

The techniques disclosed herein relate to a display substrate and a display device.

As an example of a display substrate included in a display device in the related art, there is known an active matrix substrate described in JP 2021-105638 A. An active matrix substrate described in JP 2021-105638 A includes a lower insulating layer covering a light blocking layer, a pixel TFT including an oxide semiconductor layer, a gate wiring line in a row direction and a source wiring line in a column direction, a common electrode including a touch sensor electrode segment provided on an interlayer insulating layer covering a pixel electrode and a wiring line, and a touch wiring line in the column direction, in which the source wiring line and the touch wiring line are located between the substrate and the lower insulating layer, and are formed from the same film as the light blocking layer, the pixel electrode is formed from the same film as the oxide semiconductor layer, a pair of gate wiring lines are connected to one pixel row and one source wiring line is connected to a pair of pixel columns, the pair of pixel columns including a first pixel column and a second pixel column adjacent to the first pixel column, and when viewed from a normal direction of a main surface of the substrate, each source wiring line is disposed between corresponding first pixel column and second pixel column, and each touch wiring line is disposed between two adjacent ones of the pixel columns.

### SUMMARY

In the active matrix substrate described in JP 2021-105638 A, a touch sensor electrode overlaps a touch wiring line. In such a configuration, a large parasitic capacitance is generated between the touch wiring line and the touch sensor electrode that is not connected to the touch wiring line, and thus a potential of the touch sensor electrode may be adversely affected. In order to reduce such an adverse effect, for example, a portion of the touch sensor electrode overlapping the touch wiring line may be provided with a slit. This slit cannot be formed over the entire length of the touch sensor electrode. Thus, a difference in an intensity of an electric field generated between a source wiring line and a touch electrode occurs between the slit and the portion of the touch electrode in which the slit is not formed. As a result, the difference may be visually recognized as display unevenness.

The techniques described herein have been made based on the circumstances described above, and an object thereof is to suppress the occurrence of display unevenness.

(1) A display substrate according to a techniques described herein includes a first wiring line formed of a first conductive film and extending along a first direction, a first switching element connected to the first wiring line, a second switching element connected to the first wiring line, a second wiring line formed of a second conductive film disposed on an upper layer side of the first conductive film via a first insulating film, extending along the first direction, and overlapping the first wiring line, a first electrode formed of a third conductive film disposed on an upper layer side of the second conductive film via a second insulating film and connected to the first switching element, a second electrode formed of a portion of the third conductive film different from the first electrode and connected to the second switching element, and a third electrode formed of a fourth conductive film disposed on an upper layer side of the third conductive film via a third insulating film and overlapping the first electrode and the second electrode, in which the third electrode includes a first slit extending along the first direction and overlapping a part of the second wiring line, a second slit extending along the first direction, overlapping a part of the second wiring line, and disposed spaced apart in the first direction with respect to the first slit, and a remaining portion overlapping a part of the second wiring line and remaining between the first slit and the second slit in the first direction, the first electrode includes a first overlapping portion that is disposed side by side with respect to the first slit in a second direction intersecting the first direction but is not disposed side by side with respect to the remaining portion in the second direction, and overlaps at least a part of the first slit, and the second electrode includes a second overlapping portion that is disposed side by side with respect to the remaining portion in the second direction and overlaps at least a part of the remaining portion.

(2) In addition to (1), in the display substrate, the third electrode may be formed wider than the second wiring line so that the first slit includes a first region which overlaps the second wiring line and a second region which does not overlap the second wiring line, and the first overlapping portion may overlap at least the second region of the first slit.

(3) In addition to (1) or (2), the display substrate may further include a third switching element connected to the first wiring line, a fourth electrode formed of a portion of the third conductive film different from the first electrode and the second electrode and connected to the third switching element, and a fifth electrode formed of a portion of the fourth conductive film different from the third electrode and overlapping the fourth electrode, in which the second wiring line is connected to the fifth electrode.

(4) In addition to (3), the display substrate may further include a third wiring line formed of a portion of the first conductive film different from the first wiring line and extending along the first direction, a fourth wiring line formed of a portion of the second conductive film different from the second wiring line, extending along the first direction, and overlapping the third wiring line, and a signal supply unit connected to one end portion of each of the first wiring line and the third wiring line and configured to supply a signal to each of the first wiring line and the third wiring line, in which the fifth electrode is disposed at a position farther from the signal supply unit than the third electrode in the first direction, and the fourth wiring line is connected to the third electrode.

(5) A display device according to techniques described herein includes the display substrate according to any one of the above-described (1) to (4) and a counter substrate disposed to face the display substrate and spaced apart from the display substrate.

According to the techniques described herein, the occurrence of display unevenness can be suppressed.

### BRIEF DESCRIPTION OF DRAWINGS

The disclosure will be described with reference to the accompanying drawings, wherein like numbers reference like elements.

FIG. 1 is a plan view illustrating a liquid crystal panel, a driver, a flexible substrate, and the like that constitute a liquid crystal display device according to a first embodiment.

FIG. 2 is a plan view illustrating a pixel arrangement in a display region of an array substrate constituting the liquid crystal panel according to the first embodiment, and is a plan view illustrating each configuration including a first metal film, a semiconductor film, a second metal film, and a first transparent electrode film with different shadings.

FIG. 3 is a plan view illustrating the same range as in FIG. 2 in a display region of the array substrate according to the first embodiment, and is a plan view illustrating a configuration including a second transparent electrode film with a shading.

FIG. 4 is a cross-sectional view of the liquid crystal panel according to the first embodiment taken along a line iv-iv in FIG. 2.

FIG. 5 is a cross-sectional view illustrating a structure for connection between a touch electrode and a touch wiring line in the array substrate according to the first embodiment.

FIG. 6 is a plan view schematically illustrating a relationship among a driver, the touch electrodes, source wiring lines, the touch wiring lines, and dummy wiring lines included in the array substrate according to the first embodiment.

FIG. 7 is an enlarged plan view of the vicinity of a first TFT adjacent to a first slit included in the first touch electrode in the display region of the array substrate according to the first embodiment, and is a plan view illustrating each configuration including a first metal film, a semiconductor film, a second metal film, and a first transparent electrode film with different shadings.

FIG. 8 is an enlarged plan view of the vicinity of the first TFT adjacent to the first slit included in the first touch electrode in the display region of the array substrate according to the first embodiment, and is a plan view illustrating the configuration including a second transparent electrode film with a shading.

FIG. 9 is a cross-sectional view of the array substrate according to the first embodiment taken along a line x-x in FIG. 8.

FIG. 10 is an enlarged plan view of the vicinity of a second TFT adjacent to a remaining portion included in the first touch electrode in the display region of the array substrate according to the first embodiment, and is a plan view illustrating each configuration including a first metal film, a semiconductor film, a second metal film, and a first transparent electrode film with different shadings.

FIG. 11 is an enlarged plan view of the vicinity of the second TFT adjacent to the remaining portion included in the first touch electrode in the display region of the array substrate according to the first embodiment, and is a plan view illustrating the configuration including a second transparent electrode film with a shading.

FIG. 12 is a cross-sectional view of the array substrate according to the first embodiment taken along a line xii-xii in FIG. 10.

### DESCRIPTION OF EMBODIMENTS

### First Embodiment

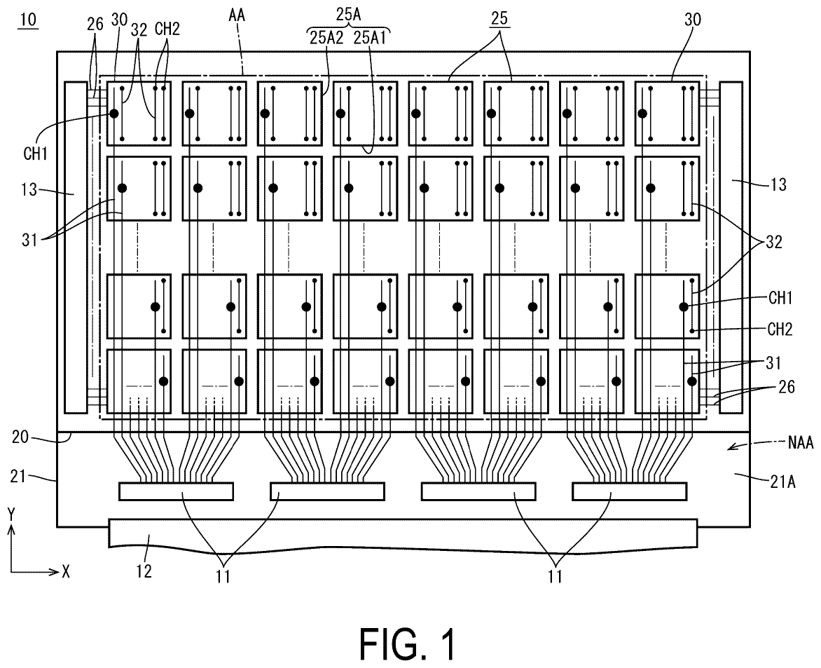

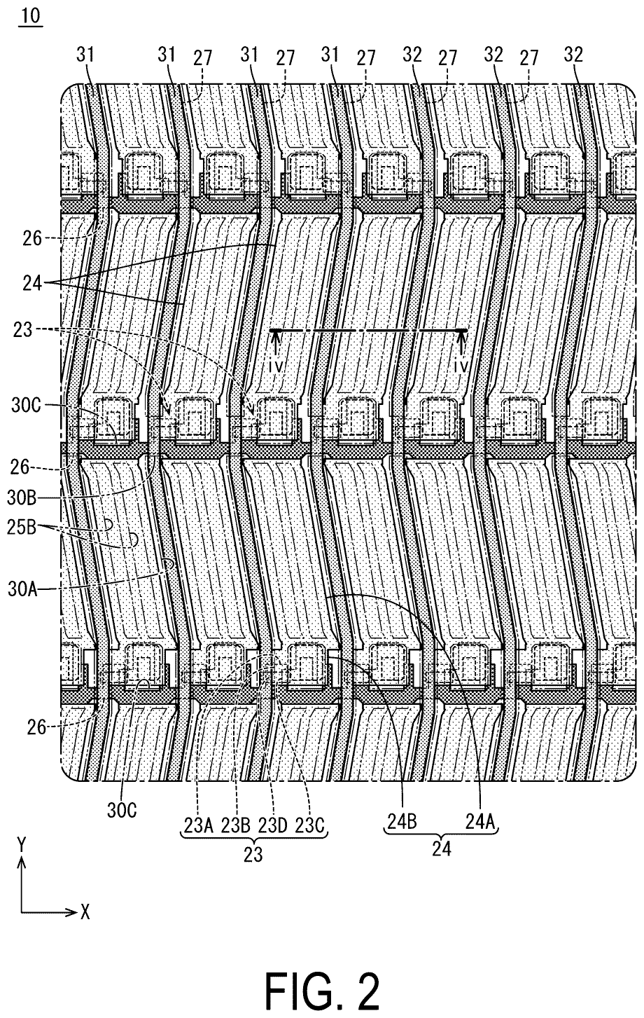

A first embodiment will be described with reference to FIGS. 1 to 12. In the present embodiment, an example of a liquid crystal panel (display device) 10 having an image display function and a touch panel function (position input function, position detection function) will be described. Note that some drawings illustrate an X-axis, a Y-axis, and a Z-axis, and directions of these axes are drawn so as to be common in all the drawings. In addition, an upper side and a lower side in each of FIGS. 2, 4, 5, 9, and 12 are respectively defined as a front side and a rear side.

A schematic planar configuration of the liquid crystal panel 10 will now be described with reference to FIG. 1. As illustrated in FIG. 1, the liquid crystal panel 10 has a horizontally elongated, substantially rectangular shape as a whole in a plan view. A short side direction, a long side direction, and a plate thickness direction (normal direction of a main surface of each substrate 20, 21) of this liquid crystal panel 10 coincide with a Y-axis direction, an X-axis direction, and a Z-axis direction, respectively. In the present embodiment, the Y-axis direction is a “first direction” and the X-axis direction is a “second direction.” The liquid crystal panel 10 can display an image by using illumination light emitted from a backlight device (illumination device) provided on the rear side thereof. The backlight device is disposed on a rear side (back face side) with respect to the liquid crystal panel 10, and includes a light source (for example, a light emitting diode (LED)), an optical member configured to impart an optical effect on light from the light source, thereby converting the light into planar light, and the like, for example.

In the liquid crystal panel 10, as illustrated in FIG. 1, a center portion of a screen is established as a display region (range surrounded by a dot-dash line in FIG. 1) AA in which images are displayed. In contrast, a frame-shaped (frame-formed) outer peripheral portion surrounding the display region AA of the screen of the liquid crystal panel 10 is a non-display region NAA in which images are not displayed. The liquid crystal panel 10 is formed by bonding the pair of substrates 20, 21 together. The substrate on a front side (front face side) of the pair of substrates 20, 21, is the counter substrate 20, and the substrate on a rear side (back face side) is the array substrate (display substrate, active matrix substrate) 21. The counter substrate 20 and the array substrate 21 are each formed by layering various films on an inner face side of a glass substrate. Note that polarizers are bonded to outer face sides of both the substrates 20, 21, respectively.

The counter substrate 20, as illustrated in FIG. 1, has a short side dimension that is shorter than a short side dimension of the array substrate 21, and is bonded to the array substrate 21 with one end portion in a short side direction (Y-axis direction) aligned with the array substrate 21. Accordingly, the other end portion in the short side direction of the array substrate 21 is a protruding portion 21A protruding laterally with respect to the counter substrate 20 and not overlapping the counter substrate 20. In this protruding portion 21A, a driver (signal supply unit) 11, for supplying various signals for the display function and the touch panel function described below, and a flexible substrate 12 are mounted. The driver 11 is mounted on the protruding portion 21A of the array substrate 21 in a chip-on-glass (COG) manner. The driver 11 is composed of a large-scale integration (LSI) chip including a drive circuit in an interior thereof, and processes various signals transmitted by the flexible substrate 12. Note that the driver 11 can be described as being disposed on one end side of the display region AA of the array substrate 21 in the Y-axis direction. The flexible substrate 12 has a configuration in which a wiring line pattern including a plurality of wiring lines is formed on a base material made of a synthetic resin material (for example, a polyimide resin) having insulating properties and flexibility. One end side portion of the flexible substrate 12 is connected to the array substrate 21, and the other end side portion thereof is connected to an external control substrate (signal supply source). Various signals supplied from the control substrate are transmitted to the liquid crystal panel 10 via the flexible substrate 12. Further, in the non-display region NAA of the array substrate 21, a pair of gate circuit portions 13 are provided, sandwiching the display region AA therebetween from both sides in the X-axis direction. The gate circuit portions 13 are each configured to supply a scanning signal to a gate wiring line 26 described below, and monolithically provided to the array substrate 21.

The liquid crystal panel 10 according to the present embodiment has both a display function for displaying an image and a touch panel function for detecting a position (input position) input by a user based on the displayed image. In the liquid crystal panel 10, a touch panel pattern for exhibiting the touch panel function is integrated (in an in-cell form). The touch panel pattern is a so-called projected electrostatic capacitance type, and the detection type thereof is a self-capacitance type. As illustrated in FIG. 1, the touch panel pattern is constituted by a plurality of touch electrodes (position detection electrodes) 30 disposed side by side in a matrix shape in a main surface of the liquid crystal panel 10. The touch electrodes 30 are disposed in the display region AA of the liquid crystal panel 10. Accordingly, the display region AA of the liquid crystal panel 10 substantially matches a touch region (position input region) in which an input position can be detected. Note that the non-display region NAA substantially matches a non-touch region (non-position input region) in which an input position cannot be detected. Then, when the user brings a position input member, which is a conductor such as a finger of the user or a touch pen operated by the user, close to the surface (display surface) of the liquid crystal panel 10 based on an image displayed in the display region AA of the liquid crystal panel 10, electrostatic capacitance is formed between the position input member and the touch electrode 30. Thereby, the electrostatic capacitance detected with the touch electrode 30 being close to the position input member changes as the position input member approaches thereto, and is different from the electrostatic capacitance of the touch electrode 30 being far from the position input member. Based on the difference in electrostatic capacitance, a detection circuit described below can detect an input position.

As illustrated in FIG. 1, the plurality of touch electrodes 30 are disposed side by side spaced apart along the X-axis direction and the Y-axis direction in the display region AA. The touch electrode 30 has a substantially rectangular shape in a plan view, with one side having a dimension of several millimeters. The touch electrode 30 is much larger than a pixel PX described below in a plan view, and is disposed in a range over a plurality (approximately several tens to several hundreds) of pixels PX in the X-axis direction and the Y-axis direction. A detailed configuration of the touch electrode 30 will be described below.

As illustrated in FIG. 1, a plurality of touch wiring lines (position detection wiring lines) 31 provided in the liquid crystal panel 10 are selectively connected to the plurality of touch electrodes 30. The touch wiring lines 31 extend substantially along the Y-axis direction. One end portion of the touch wiring line 31 in the Y-axis direction is connected to the driver 11 in the non-display region NAA. The other end portion of the touch wiring line 31 in the Y-axis direction is connected to a specific touch electrode 30 among the plurality of touch electrodes 30 aligned with each other along the Y-axis direction in the display region AA. The formation range of the touch wiring line 31 in the Y-axis direction is limited to a range from the driver 11 to the touch electrode 30 to be connected thereto, and the touch wiring line 31 is not disposed on a side (upper side in FIG. 1) opposite to the driver 11 side (lower side in FIG. 1) of the touch electrode 30 to be connected thereto. Note that, in FIG. 1, a black dot represents the connection location (first contact hole CH1) of the touch wiring line 31 to the touch electrode 30. Furthermore, the touch wiring line 31 is connected to a detection circuit. The detection circuit may be provided in the driver 11, or may be provided outside of the liquid crystal panel 10 and connected via the flexible substrate 12. A detailed configuration of the touch wiring line 31 will be described below.

As illustrated in FIG. 1, a plurality of dummy wiring lines (connection wiring lines) 32 provided in the liquid crystal panel 10 are connected to the plurality of touch electrodes 30. The dummy wiring lines 32 extend substantially along the Y-axis direction, similarly to the touch wiring lines 31. The dummy wiring line 32 overlaps the touch electrode 30 to be connected thereto, and the formation range thereof in the Y-axis direction is limited to the formation range in the Y-axis direction of the touch electrode 30 to be connected thereto. The dummy wiring line 32 is connected to the touch electrode 30 to be connected thereto at a plurality of locations. Note that, in FIG. 1, a black dot represents the connection location (second contact hole CH2) of the dummy wiring line 32 to the touch electrode 30. A resistance distribution of the touch electrode 30 is reduced by such a dummy wiring line 32.

A pixel arrangement in the display region AA of the array substrate 21 will now be described with reference to FIG. 2. In FIG. 2, configurations including a first metal film, a semiconductor film, a second metal film, and a first transparent electrode film included in the array substrate 21 are illustrated with different shadings. Note that, in FIG. 2, a configuration including a second transparent electrode film and a configuration included in the counter substrate 20 and the like are indicated by chain double-dashed lines. Further, the respective films provided on the array substrate 21 described above will be described in detail below. As illustrated in FIG. 2, on an inner face side of the display region AA of the array substrate 21, a plurality of thin film transistors (TFTs; switching elements) 23 and a plurality of pixel electrodes 24 are provided side by side spaced apart within a main surface of the array substrate 21. The plurality of TFTs 23 and the plurality of pixel electrodes 24 are provided side by side in a matrix shape and spaced apart in the X-axis direction and the Y-axis direction. The gate wiring lines (scanning wiring lines) 26 and source wiring lines (image wiring lines, signal wiring lines) 27, which are formed in a lattice pattern, surround the TFT 23 and the pixel electrode 24. The gate wiring line 26 extends substantially linearly along the X-axis direction, and a plurality of the gate wiring lines 26 are disposed side by side spaced apart in the Y-axis direction, sandwiching the pixel electrode 24 therebetween. A line width of the gate wiring line 26 changes depending on the position thereof in the X-axis direction. One end portion of each of a plurality of the gate wiring lines 26 in the X-axis direction is connected to the gate circuit portion 13. The source wiring line 27 extends substantially along the Y-axis direction while being repeatedly bent into a zigzag shape. A plurality of the source wiring lines 27 are disposed side by side spaced apart in the X-axis direction, sandwiching the pixel electrode 24 therebetween. The gate wiring line 26 and the source wiring line 27 intersect each other. One end portion of each of the plurality of source wiring lines 27 in the Y-axis direction is connected to the driver 11.

As illustrated in FIG. 2, the touch wiring line 31 overlaps a specific source wiring line 27 of the plurality of source wiring lines 27 in a plan view. Similar to the source wiring line 27, the touch wiring line 31 extends substantially along the Y-axis direction while being repeatedly bent into a zigzag shape. The dummy wiring line 32 overlaps a source wiring line 27 of the plurality of source wiring lines 27 which does not overlap the touch wiring line 31 or a portion of the source wiring line 27 which does not overlap the touch wiring line 31, in a plan view. Similar to the source wiring line 27, the dummy wiring line 32 extends substantially along the Y-axis direction while being repeatedly bent into a zigzag shape. The touch wiring line 31 and the dummy wiring line 32 have line widths (dimensions in the X-axis direction) substantially equal to the line width of the source wiring line 27, and have a relationship in which the touch wiring line 31 and the dummy wiring line 32 overlap the source wiring line 27 over substantially the entire width. The TFT 23 is interposed between the pixel electrode 24 and the gate wiring line 26, which are connected to the TFT 23, in the Y-axis direction. Note that the plurality of TFTs 23 include those positioned on the right side in FIG. 2 with respect to the source wiring line 27 to be connected thereto, and those positioned on the left side in the same drawing. Two of the TFTs 23 positioned on the right side in FIG. 2 with respect to the source wiring line 27 to be connected thereto and two of the TFTs 23 positioned on the left side in the same drawing are alternately aligned two by two in the Y-axis direction. Further, all of the TFTs 23 are positioned on the lower side in FIG. 2 with respect to the pixel electrodes 24 to be connected thereto.

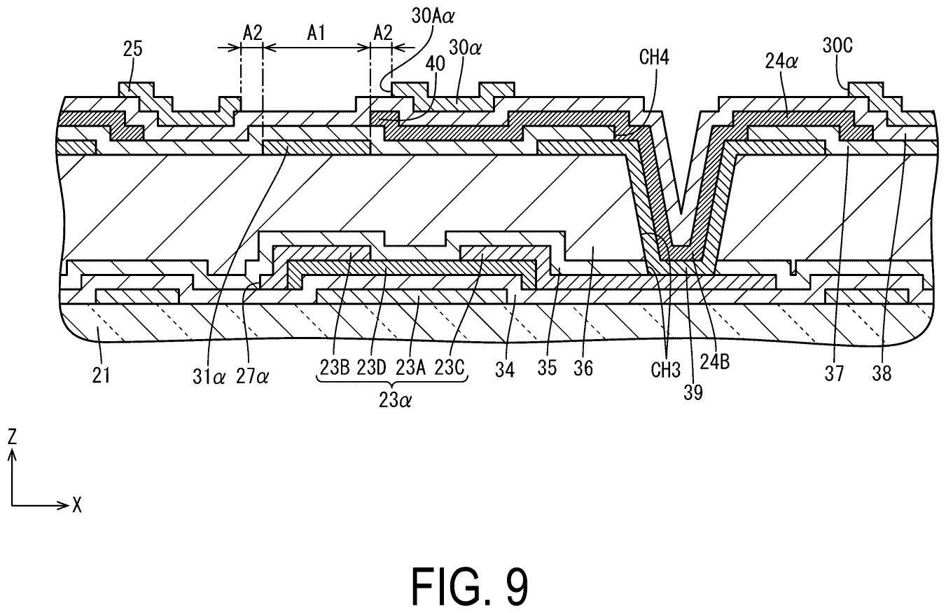

As illustrated in FIG. 2, the pixel electrode 24 includes the pixel electrode main body 24A with a substantially rectangular shape being longitudinally elongated. A long side of the pixel electrode main body 24A extends along the source wiring line 27. Specifically, both side edges of the pixel electrode main body 24A in the longitudinal direction are slightly inclined relative to the Y-axis direction. In addition, the pixel electrode 24 includes the contact portion 24B protruding to one side in the Y-axis direction from the pixel electrode main body 24A. The contact portion 24B protrudes to the TFT 23 to be connected thereto side (downward in FIG. 2) from the pixel electrode main body 24A, and overlaps a greater portion of the drain electrode 23C included in the TFT 23. The contact portion 24B is an area of the pixel electrode 24 that is connected to the drain electrode 23C (refer to FIG. 9).

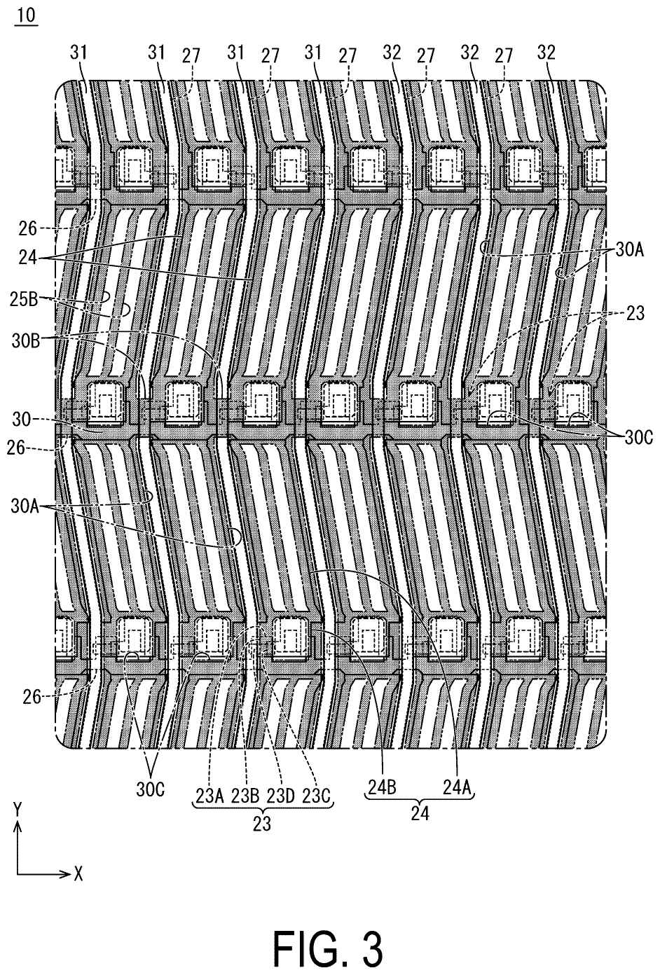

Next, a common electrode 25 and the touch electrode 30 included in the array substrate 21 will be described with reference to FIG. 1 and FIG. 3. In FIG. 3, the configuration including the second transparent electrode film included in the array substrate 21 is illustrated with a shading. As illustrated in FIG. 3, the array substrate 21 is provided with the common electrode 25 disposed across substantially the entire display region AA. The common electrode 25 overlaps a lower layer side of all the pixel electrodes 24. As illustrated in FIG. 1, the common electrode 25 constitutes the touch electrode 30 described above. The common electrode 25 includes a partitioning opening portion (partitioning slit) 25A partitioning between the adjacent touch electrodes 30. The partitioning opening portion 25A includes a first partitioning opening portion 25A1 extending along substantially the X-axis direction across the entire lateral length of the common electrode 25 and a second partitioning opening portion 25A2 extending along substantially the Y-axis direction across the entire vertical length of the common electrode 25, and has a substantially lattice shape as a whole in a plan view. The common electrode 25 constitutes a plurality of touch electrodes 30 that are partitioned by the partitioning opening portion 25A to form a substantially grid shape in a plan view, and are each electrically independent from the other. A common potential signal related to the image display function and a touch signal (position detection signal) related to the touch panel function are supplied to the touch wiring line 31 connected to the touch electrode 30 from the driver 11 in a time division manner. The timing at which the common potential signal is supplied from the driver 11 to the touch wiring line 31 is a display period, and the timing at which the touch signal is supplied from the driver 11 to the touch wiring line 31 is the sensing period (position detection period). This common potential signal is transmitted to all of the touch wiring lines 31 at the same timing (display period). As a result, all of the touch electrodes 30 are at the reference potential based on the common potential signal and thus function as the common electrode 25.

As illustrated in FIG. 3, a slit 30A overlapping the touch wiring line 31 and the dummy wiring line 32 (source wiring line 27) is provided in each of the plurality of touch electrodes 30 constituting the common electrode 25. Similar to the source wiring line 27 and the dummy wiring line 32, the slit 30A extends substantially along the Y-axis direction while being repeatedly bent into a zigzag shape. In this manner, when the slit 30A is disposed in the touch electrode 30, parasitic capacitance generated between the touch wiring line 31 and the touch electrode 30 that is not connected to the touch wiring line 31 can be reduced. The length of the slit 30A (dimension in the Y-axis direction) is shorter than the lengths of the touch wiring line 31 and the dummy wiring line 32, and is, for example, about a size across two pixel electrodes 24 aligned with each other in the Y-axis direction. A plurality of the slits 30A are disposed spaced apart in the Y-axis direction with respect to one touch wiring line 31 or one dummy wiring line 32. Thus, the touch electrode 30 includes a remaining portion 30B that remains interposed between two slits 30A aligned with each other spaced apart in the Y-axis direction. A plurality of the remaining portions 30B are disposed side by side spaced apart with a space corresponding to the length of the slit 30A in the Y-axis direction. The remaining portion 30B is aligned with the TFT 23 in the X-axis direction and overlaps the gate wiring line 26. Portions of the touch electrode 30 adjacent to each other in the X-axis direction with the slit 30A interposed therebetween are connected to each other by the remaining portion 30B. In this manner, the remaining portion 30B prevents the touch electrode 30 from being divided into a plurality of portions in the X-axis direction. Further, each of the plurality of touch electrodes 30 is formed with an opening portion 30C that overlaps a drain electrode 23C of the TFT 23 (in the vicinity of a third contact hole CH3 and a fourth contact hole CH4 described below). A plurality of the opening portions 30C are formed at positions in the touch electrode 30 which overlap the drain electrodes 23C included in the plurality of TFTs 23, respectively. Short-circuiting of the touch electrode 30 to the pixel electrode 24 is avoided by the opening portion 30C.

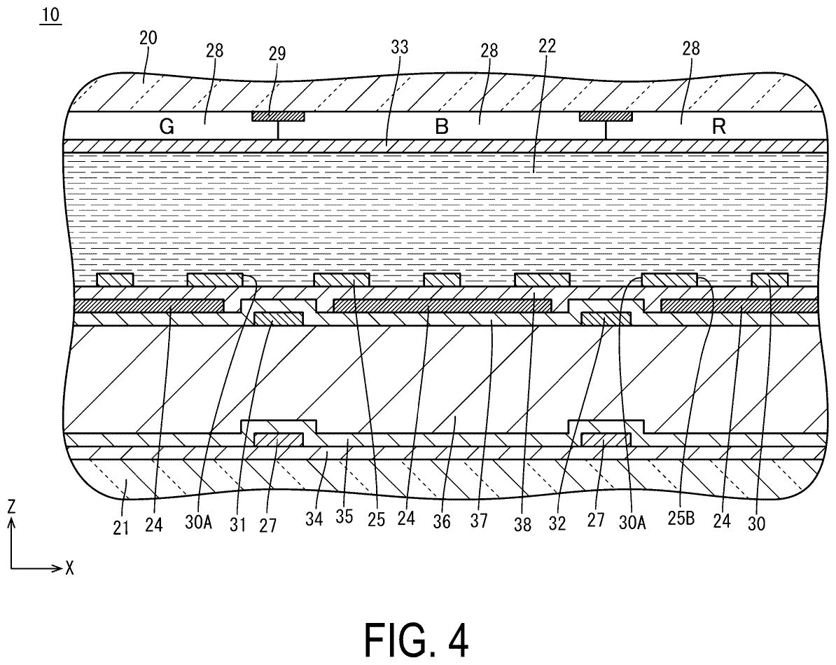

A cross-sectional configuration in the vicinity of a center portion of the pixel electrode 24 in the Y-axis direction in the liquid crystal panel 10 will now be described with reference to FIG. 4. As illustrated in FIG. 4, the liquid crystal panel 10 includes a liquid crystal layer (medium layer) 22 that is disposed between the pair of substrates 20 and 21 and containing liquid crystal molecules, which are substances having optical characteristics that change in accordance with application of an electrical field. On the inner face side of the display region AA of the array substrate 21, the common electrode 25 is formed on the upper layer side than the pixel electrodes 24 so as to overlap all of the pixel electrodes 24. A plurality of pixel slits 25B are each provided to the common electrode 25 at a respective one of positions overlapping a respective one of the pixel electrodes 24. The plurality of pixel slits 25B extend in parallel with a long side (outer shape) of each of the pixel electrodes 24, and are disposed side by side spaced apart in the X-axis direction at the respective one of positions overlapping the respective one of the pixel electrodes 24. The common electrode 25 is supplied with a common potential signal (reference potential signal) of a common potential (reference potential), except for a period (sensing period) during which a touch signal (position detection signal) is supplied to detect the input position by the position input member, and extends substantially across the entire display region AA. When a potential difference is generated as the pixel electrodes 24 are charged between the pixel electrodes 24 and the common electrodes 25 overlapping each other, a fringe electrical field (oblique electrical field) including a component along the main surface of the array substrate 21 as well as a component in a direction normal to the plate surface of the array substrate 21 is generated between opening edges of the pixel slits 25B in the common electrodes 25 and the pixel electrodes 24. Accordingly, by using this fringe electrical field, it is possible to control the alignment state of the liquid crystal molecules included in the liquid crystal layer 22. In other words, the liquid crystal panel 10 according to the present embodiment has an operation mode of a fringe field switching (FFS) mode.

As illustrated in FIG. 4, three-color color filters 28 exhibiting blue (B), green (G), and red (R) are provided in the display region AA on an inner face side of the counter substrate 20 constituting the liquid crystal panel 10. The plurality of color filters 28 exhibiting colors different from each other are disposed side by side so as to be adjacent to each other in the extension direction of the gate wiring line 26 (X-axis direction). The plurality of color filters 28 exhibiting colors different from each other extend along the extension direction of the source wiring line 27 (substantially the Y-axis direction). In this manner, the plurality of color filters 28 exhibiting colors different from each other are arrayed in a stripe pattern as a whole. These color filters 28 overlap the pixel electrodes 24 on the array substrate 21 side in a plan view, and constitute pixels, which are display units, together with the pixel electrodes 24. The plurality of color filters 28 exhibiting colors different from each other are disposed such that boundaries thereof (color boundaries) overlap the source wiring line 27 (the touch wiring line 31 and the dummy wiring line 32). A light blocking portion (inter-pixel light blocking portion, black matrix) 29 located on a lower layer side of the color filter 28 is provided on the inner face side of the counter substrate 20. The light blocking portion 29 is made of a light blocking material having an excellent light-blocking property. The light blocking portion 29 can block light emitted from a backlight device or the like. In the display region AA, the light blocking portion 29 has a planar shape being in a substantially lattice pattern, and partitions adjacent pixel electrodes 24 (pixels). The light blocking portion 29 overlaps at least the gate wiring line 26 and the source wiring line 27 on the array substrate 21 side in a plan view. Further, an overcoat film 33 disposed in a solid-like form over substantially the entire region of the counter substrate 20 is provided for flattening on the upper layer side (liquid crystal layer 22 side) of the color filter 28. Note that alignment films for aligning the liquid crystal molecules included in the liquid crystal layer 22 are respectively formed on innermost faces (uppermost layers) in contact with the liquid crystal layer 22 of both the substrates 20, 21.

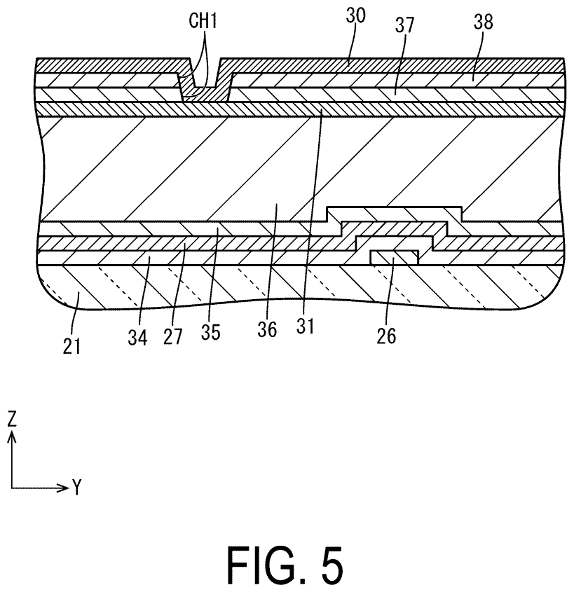

Next, a connection structure between the touch electrode 30 and the touch wiring line 31 will be described with reference to FIG. 5. As illustrated in FIG. 5, the touch wiring line 31 is disposed on a lower layer side of the touch electrode 30 via a second interlayer insulating film 37 and a third interlayer insulating film 38, which will be described later. The first contact hole CH1 is communicably formed to be opened at a position of the second interlayer insulating film 37 and the third interlayer insulating film 38 overlapping both the touch wiring line 31 and the touch electrode 30 to be connected there to of the touch wiring line 31. The touch wiring line 31 and the touch electrode 30 are connected to each other through the first contact hole CH1. The first contact hole CH1 is disposed in the vicinity of an intersection between the gate wiring line 26 and the source wiring line 27.

The various films layered and formed on the inner face side of the array substrate 21 will now be described with reference to FIG. 9. FIG. 9 is a cross-sectional view of the vicinity of the TFT 23 in the array substrate 21. As illustrated in FIG. 9, in the array substrate 21, the first metal film, a gate insulating film 34, a semiconductor film, the second metal film (first conductive film), a first interlayer insulating film (first insulating film) 35, a flattening film (first insulating film) 36, the third metal film (second conductive film), a second interlayer insulating film (second insulating film) 37, a first transparent electrode film (third conductive film), a third interlayer insulating film (third insulating film) 38, a second transparent electrode film (fourth conductive film), and the alignment film are layer-formed in that order from the lower layer side (glass substrate side). The first metal film, the second metal film, and the third metal film are each a single layer film composed of one type of metal material selected from copper, titanium, aluminum, molybdenum, tungsten, and the like, or a layered film or alloy composed of different types of metal materials, and thus have conductivity and light-blocking properties. The first metal film constitutes the gate wiring line 26, a gate electrode 23A of the TFT 23, and the like. The second metal film constitutes the source wiring line 27, a source electrode 23B and a drain electrode 23C of the TFT 23, and the like. The third metal film constitutes the touch wiring line 31, the dummy wiring line 32, and the like. The semiconductor film is composed of a thin film using, for example, an oxide semiconductor or amorphous silicon as the material thereof, and constitutes a semiconductor portion 23D of the TFT 23, and the like. The first transparent electrode film and the second transparent electrode film are composed of a transparent electrode material (for example, indium tin oxide (ITO) or indium zinc oxide (IZO)). The first transparent electrode film constitutes the pixel electrode 24 and the like. The second transparent electrode film constitutes the common electrode 25 (touch electrode 30) and the like. The alignment film is as described above.

The gate insulating film 34, the first interlayer insulating film 35, the second interlayer insulating film 37, and the third interlayer insulating film 38 are each made of an inorganic material such as silicon nitride (SiNₓ) or silicon oxide (SiO₂). The flattening film 36 is made of, for example, an organic material such as PMMA (acrylic resin). The flattening film 36 has a film thickness of, for example, about 1 μm to about 3 μm, which is much larger than the film thicknesses of the gate insulating film 34, the first interlayer insulating film 35, the second interlayer insulating film 37, and the third interlayer insulating film 38. This flattening film 36 flattens an inner face of the array substrate 21 (surface on the liquid crystal layer 22 side). The gate insulating film 34 maintains an insulated state between the first metal film on the lower layer side and the semiconductor film and the second metal film on the upper layer side. For example, an intersection between the gate wiring line 26 composed of the first metal film and the source wiring line 27 composed of the second metal film is maintained in an insulated state by the gate insulating film 34. In addition, in the TFT 23, an overlapping area between the gate electrode 23A composed of the first metal film and the semiconductor portion 23D composed of the semiconductor film is maintained in an insulated state by the gate insulating film 34. The first interlayer insulating film 35 and the flattening film 36 maintain an insulated state between the semiconductor film and the second metal film on the lower layer side and the third metal film on the upper layer side. For example, an overlapping area between the source wiring line 27 composed of the second metal film and the touch wiring line 31 or the dummy wiring line 32 composed of the third metal film is maintained in an insulated state by the first interlayer insulating film 35 and the flattening film 36. The second interlayer insulating film 37 maintains the insulated state between the third metal film on the lower layer side and the first transparent electrode film on the upper layer side. For example, the touch wiring line 31, the dummy wiring line 32, and the like composed of the third metal film, and the pixel electrode 24 composed of the first transparent electrode film are maintained in an insulated state by the second interlayer insulating film 37. The third interlayer insulating film 38 maintains an insulated state between the first transparent electrode film on the lower layer side and the second transparent electrode film on the upper layer side. For example, an overlapping area between the pixel electrode 24 composed of the first transparent electrode film and the common electrode 25 (touch electrode 30) composed of the second transparent electrode film is maintained in an insulated state by the third interlayer insulating film 38.

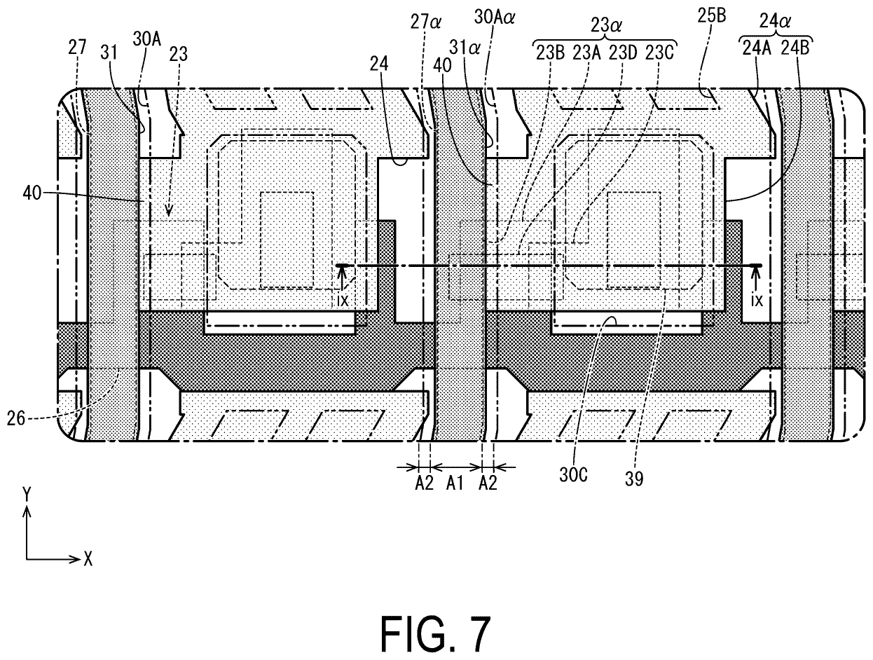

Next, a cross-sectional configuration of the TFT 23 will be described. As illustrated in FIG. 9, the TFT 23 includes the gate electrode 23A composed of the first metal film. The gate electrode 23A is constituted by a portion of the gate wiring line 26 (in the vicinity of the intersection between the gate wiring line 26 and the source wiring line 27). The gate electrode 23A is formed by partially widening the gate wiring line 26 (refer to FIG. 7). The gate electrode 23A drives the TFT 23 based on a scanning signal supplied to the gate wiring line 26. The TFT 23 includes the source electrode 23B composed of the second metal film. The source electrode 23B is constituted by a portion of the source wiring line 27 (intersection between the source wiring line 27 and the gate wiring line 26). The source electrode 23B is disposed at one end of the TFT 23 in the X-axis direction (the left end illustrated in FIG. 9). The source electrode 23B overlaps a portion of the gate electrode 23A and is connected to the semiconductor portion 23D.

As illustrated in FIG. 9, the TFT 23 includes the drain electrode 23C composed of the second metal film. The drain electrode 23C is disposed at a position spaced apart from the source electrode 23B in the X-axis direction, that is, at the other end of the TFT 23 in the X-axis direction (right end illustrated in FIG. 9). An end portion of the drain electrodes 23C on the source electrode 23B side overlaps a portion of the gate electrode 23A and is connected to the semiconductor portion 23D. The drain electrode 23C is connected to the pixel electrode 24 at an end portion on a side opposite to the source electrode 23B side. An intermediate electrode 39 composed of the third metal film is provided at a position overlapping both the drain electrode 23C and the pixel electrode 24 (contact portion 24B described below). The intermediate electrode 39 is positioned between the drain electrode 23C and the pixel electrode 24 in the Z-axis direction. The intermediate electrode 39 has an island shape, and is physically separated from the touch wiring line 31 and the dummy wiring line 32 composed of other portions of the same third metal film. In the first interlayer insulating film 35 and the flattening film 36 interposed between the drain electrode 23C and the intermediate electrode 39, the third contact hole CH3 is formed at a position overlapping the drain electrode 23C and the intermediate electrode 39. The intermediate electrode 39 is connected to the drain electrode 23C through the third contact hole CH3. In the second interlayer insulating film 37 and the third interlayer insulating film 38 interposed between the intermediate electrode 39 and the pixel electrode 24, the fourth contact hole CH4 is formed at a position overlapping the intermediate electrode 39 and the pixel electrode 24. The pixel electrode 24 is connected to the intermediate electrode 39 through the fourth contact hole CH4. Thus, the pixel electrode 24 is connected to the drain electrode 23C via the intermediate electrode 39.

As illustrated in FIG. 9, the TFT 23 includes the semiconductor portion 23D having an island shape and including a channel portion. The semiconductor portion 23D has a horizontally elongated shape extending along the X-axis direction. The semiconductor portion 23D overlaps the gate electrode 23A via the gate insulating film 34. One end side portion of the semiconductor portion 23D is connected to the source electrode 23B. The other end side portion of the semiconductor portion 23D is connected to the drain electrode 23C. A portion of the semiconductor portion 23D which overlaps the gate electrode 23A but overlaps none of the source electrode 23B and the drain electrode 23C is a channel portion that functions as a channel (current path). A portion of the semiconductor portion 23D which overlaps the source electrode 23B and the drain electrode 23C is a portion that does not function as a channel. When the TFT 23 is in an on state based on a scanning signal supplied to the gate electrode 23A, an image signal (data signal) supplied to the source wiring line 27 is supplied from the source electrode 23B to the drain electrode 23C via the semiconductor portion 23D. As a result, the pixel electrode 24 is charged to the potential based on the image signal.

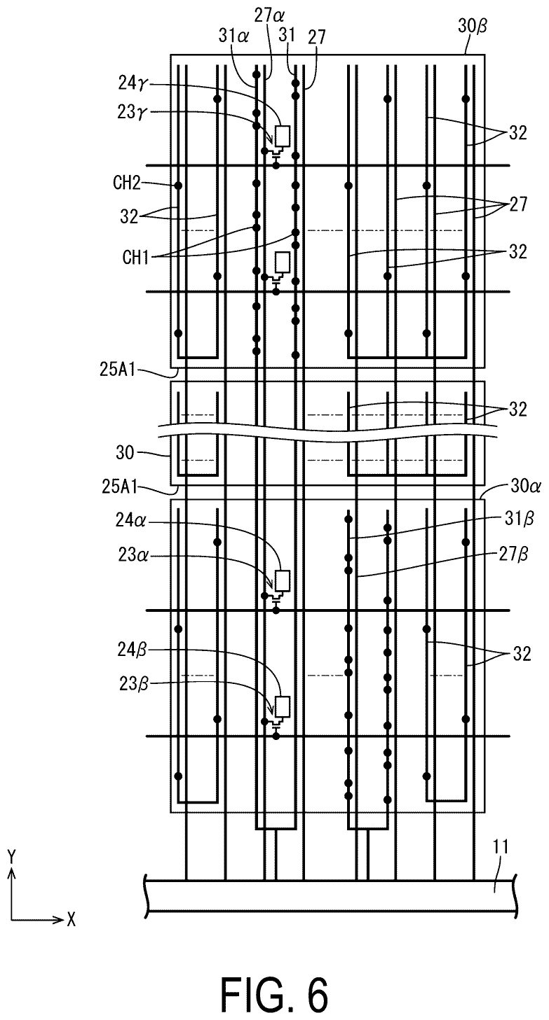

Next, a relationship among the driver 11, the touch electrode 30, the source wiring line 27, the touch wiring line 31, and the dummy wiring line 32 will be described with reference to FIG. 6. In FIG. 6, among the plurality of touch electrodes 30 aligned with each other along the Y-axis direction, a touch electrode 30 closest to the driver 11 and a touch electrode 30 farthest from the driver 11 are representatively illustrated. In FIG. 6, the source wiring line 27 overlapping the touch wiring line 31 or the dummy wiring line 32 is illustrated to be adjacent to the touch wiring line 31 or the dummy wiring line 32, respectively, on the right side of FIG. 6. First, in the liquid crystal panel 10 according to the present embodiment, as illustrated in FIG. 6, the number of the touch wiring lines 31 installed is smaller than the number of the source wiring lines 27 installed. Thus, the plurality of source wiring lines 27 include a source wiring line 27 which is not overlapped by the touch wiring line 31. The dummy wiring line 32 overlaps the source wiring line 27 which is not overlapped by the touch wiring line 31. Specifically, the plurality of touch wiring lines 31 are disposed in a central portion of the touch electrode 30 in the X-axis direction, whereas the plurality of dummy wiring lines 32 are disposed in both end side portions of the touch electrode 30 in the X-axis direction. The plurality of dummy wiring lines 32 disposed on one end side portion of the touch electrode 30 in the X-axis direction are short-circuited at one end portions, and similarly, the plurality of dummy wiring lines 32 disposed on the other end side portion of the touch electrode 30 in the X-axis direction are short-circuited at one end portions. In the present embodiment, two touch wiring lines 31 are connected to one touch electrode 30. The two touch wiring lines 31 connected to the same touch electrode 30 are bundled at a position (non-display region NAA) drawn from the display region AA to the driver 11 side.

As illustrated in FIG. 6, the formation range of the touch wiring line 31 in the Y-axis direction is limited to a range from the driver 11 to the touch electrode 30 to be connected thereto, and the touch wiring line 31 is not disposed on a side opposite to the driver 11 side (upper side in FIG. 6) in the Y-axis direction than the touch electrode 30 to be connected thereto. That is, most of the plurality of touch wiring lines 31 except for the touch wiring line 31 connected to the touch electrode 30 farthest from the driver 11 do not overlap the source wiring line 27 over the entire length thereof. The dummy wiring line 32 overlaps a portion of the source wiring line 27 partially overlapped by the touch wiring line 31 on a side opposite to the driver 11 side in the Y-axis direction than the touch electrode 30 to be connected thereto by the touch wiring line 31. Thus, the number of the dummy wiring lines 32 connected to the plurality of touch electrodes 30 aligned with each other along the Y-axis direction tends to increase as the touch electrode 30 is farther from the driver 11 in the Y-axis direction. A touch electrode 30 among the plurality of touch electrodes 30 aligned with each other along the Y-axis direction closer to the driver 11 in the Y-axis direction tends to have a larger number of touch wiring lines 31 in an overlapping relationship and in a non-connected state than the touch electrode 30 farther from the driver 11.

Here, as illustrated in FIG. 6, among the plurality of touch electrodes 30 aligned with each other along the Y-axis direction, a touch electrode 30 closest to the driver 11 is referred to as a “first touch electrode (third electrode) 30α”, and a touch electrode 30 farthest from the driver 11 is referred to as a “second touch electrode (fifth electrode) 30β”. Among the touch wiring lines 31, a touch wiring line 31 connected to the second touch electrode 30β is referred to as a “first touch wiring line (second wiring line) 31α”, and a touch wiring line 31 connected to the first touch electrode 30α is referred to as a “second touch wiring line (fourth wiring line) 31β”. Among the plurality of source wiring lines 27, a source wiring line 27 overlapping the first touch wiring line 31α is referred to as a “first source wiring line (first wiring line) 27α”, and a source wiring line 27 overlapping the second touch wiring line 31β is referred to as a “second source wiring line (third wiring line) 27β”. Among a plurality of the slits 30A provided in the first touch electrode 30α, the slit 30A located on the lower side in FIG. 6 is referred to as a “first slit 30Aα”, and the slit 30A located on the upper side in FIG. 6 is referred to as a “second slit 30Aβ”. Among the plurality of TFTs 23 connected to the first source wiring line 27α, the TFT 23 aligned with the first slit 30Aα included in the first touch electrode 30α in the X-axis direction is referred to as a “first TFT 23 (first switching element) 23α”, the TFT 23 aligned with the remaining portion 30B included in the first touch electrodes 30α in the X-axis direction is referred to as a “second TFT 23 (second switching element) 23β”, and the TFT 23 connected to the pixel electrode 24 (third pixel electrodes 24γ described below) overlapping the second touch electrode 30β is referred to as a “third TFT (third switching element) 23γ”. Among the plurality of pixel electrodes 24, the pixel electrode 24 connected to the first TFT 23α is referred to as a “first pixel electrode (first electrode) 24α”, the pixel electrode 24 connected to the second TFT 23β is referred to as a “second pixel electrode (second electrode) 24β”, and the pixel electrode 24 connected to the third TFT 23γ is referred to as a “third pixel electrode (fourth electrode) 24γ”. The first pixel electrode 24α and the second pixel electrode 24β overlap the first touch electrode 30α.

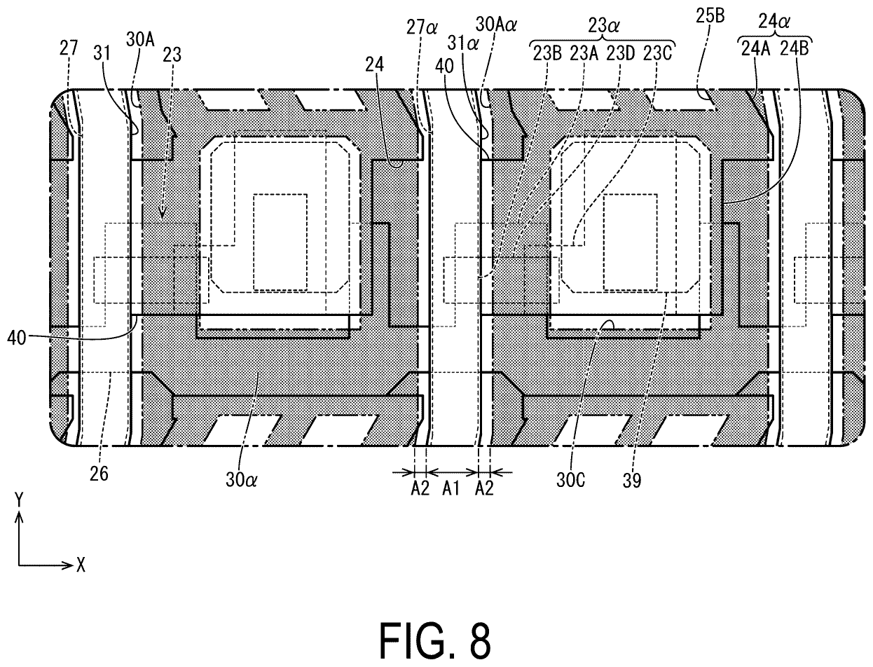

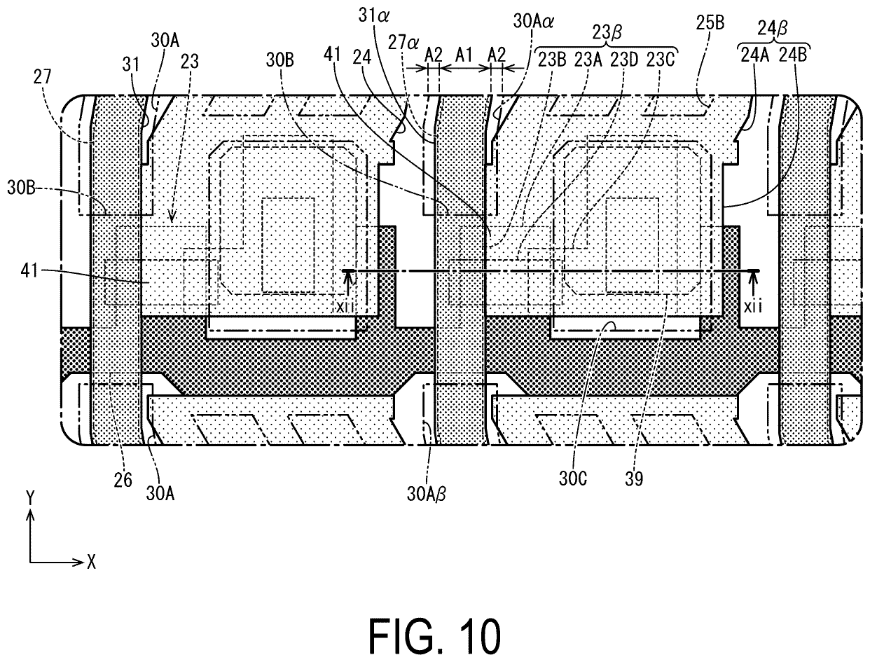

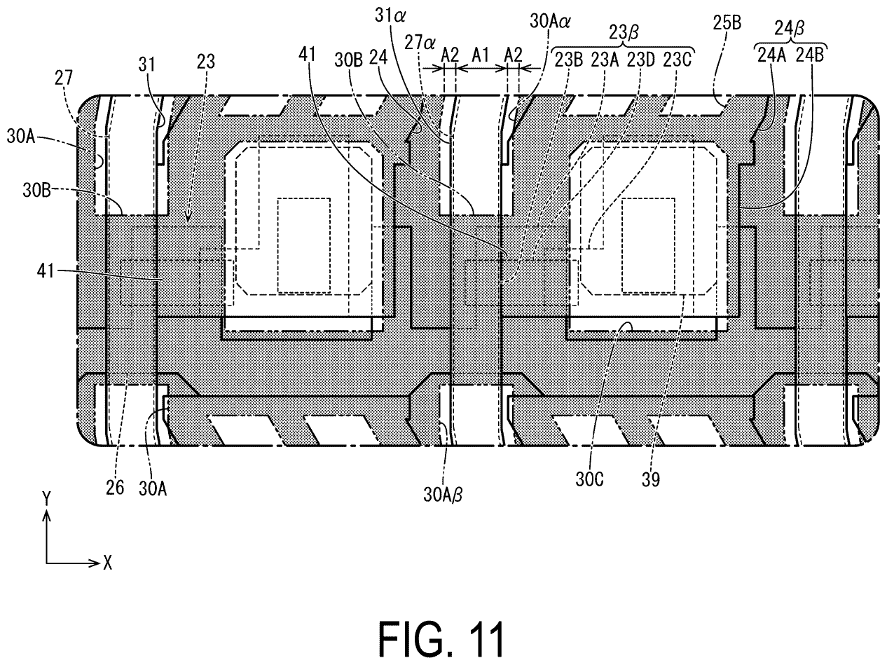

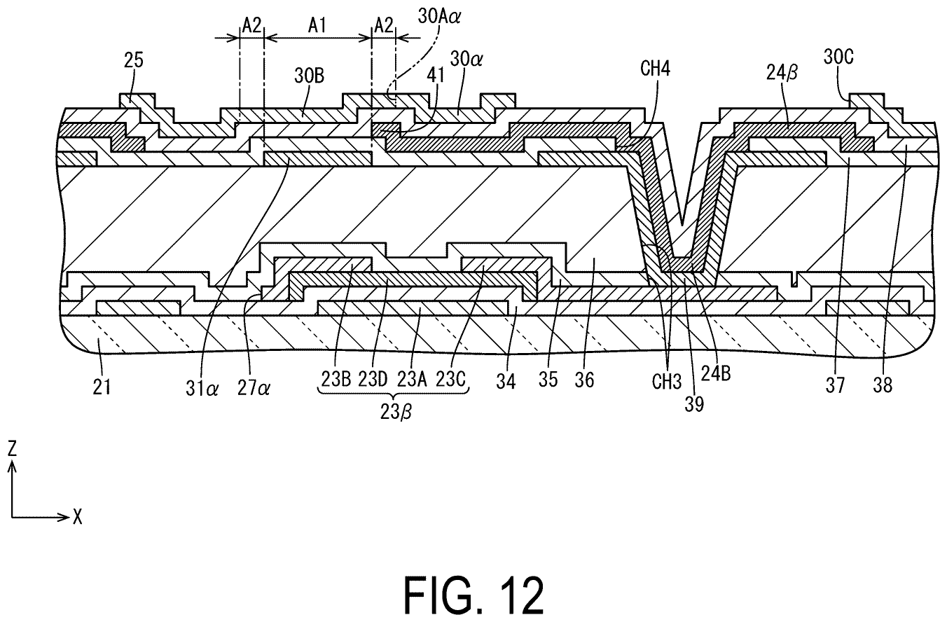

Next, a relationship among the first source wiring line 27α, the TFT 23 connected to the first source wiring line 27α, the pixel electrode 24 connected to the TFT 23, the first touch electrode 30α, and the first touch wiring line 31α will be described with reference to FIGS. 7 to 12. FIGS. 7 and 8 are enlarged plan views of the vicinity of the first TFT 23α adjacent to the first slit 30Aα included in the first touch electrode 30α. FIG. 9 is a cross-sectional view of the vicinity of the first TFT 23α adjacent to the first slit 30Aα included in the first touch electrode 30α. FIGS. 10 and 11 are enlarged plan views of the vicinity of the second TFT 23β adjacent to the remaining portion 30B included in the first touch electrode 30α. FIG. 12 is a cross-sectional view of the vicinity of the second TFT 23β adjacent to the remaining portion 30B included in the first touch electrode 30α. In FIGS. 7 and 10, configurations including a first metal film, a semiconductor film, a second metal film, and a first transparent electrode film included in the array substrate 21 are illustrated with different shadings. In FIGS. 8 and 11, the configuration including the second transparent electrode film included in the array substrate 21 is illustrated with a shading.

As illustrated in FIGS. 8 and 11, the slit 30A (the first slit 30Aα and the second slit 30Aβ) included in the first touch electrode 30α has a width (dimension in the X-axis direction) larger than a width of the touch wiring line 31 (the source wiring line 27 and the dummy wiring line 32). The slit 30A is disposed concentrically with the touch wiring line 31 in the X-axis direction. Thus, the slit 30A is disposed with both side edges thereof being spaced apart from both side edges of the touch wiring line 31 in the X-axis direction. In this manner, the slit 30A is formed wider than the touch wiring line 31 so as to include a first region A1 which overlaps the touch wiring line 31 and two second regions A2 which do not overlap the touch wiring line 31. In this manner, the parasitic capacitance generated between the touch wiring line 31 and the touch electrode 30 can be further reduced.

As illustrated in FIGS. 7 and 10, a signal transmitted by the first source wiring line 27α is supplied to the first pixel electrode 24α at a timing at which the first TFT 23α is driven, and is supplied to the second pixel electrode 24β at a timing at which the second TFT 23β is driven. As illustrated in FIGS. 9 and 12, an electric field corresponding to a potential difference is generated between the first and the second pixel electrodes 24α and 24β and the first touch electrode 30α overlapping each other via the third interlayer insulating film 38, and thus it is possible to display an image using the electric field. The first touch electrode 30α is provided with the first slit 30Aα and the second slit 30Aβ extending along the Y-axis direction and overlapping a part of the first touch wiring line 31α. Thus, the parasitic capacitance generated between the first touch wiring line 31α composed of the third metal film and the first touch electrode 30α composed of the second transparent electrode film can be reduced. As illustrated in FIG. 11, the first touch electrode 30α includes the remaining portion 30B remaining between the first slit 30Aα and the second slit 30Aβ in the Y-axis direction, and thus the first touch electrode 30α is prevented from being divided into a plurality of portions by the first slit 30Aα and the second slit 30Aβ.

On the other hand, in the vicinity of the first slit 30Aα and the second slit 30Aβ in the first touch electrode 30α, the electric field generated between the first source wiring line 27α and the first touch electrode 30α is relatively weak as illustrated in FIG. 9, whereas in the vicinity of the remaining portion 30B in the first touch electrode 30α, the electric field generated between the first source wiring line 27α and the first touch electrode 30α tends to be relatively strong as illustrated in FIG. 12. Thus, a difference may occur between a potential of the first pixel electrode 24α charged based on a signal supplied from the first source wiring line 27α to the first pixel electrode 24α via the first TFT 23α and a potential of the second pixel electrode 24β charged based on a signal supplied from the first source wiring line 27α to the second pixel electrode 24β via the second TFT 23β.

Thus, as illustrated in FIGS. 7 to 12, the first pixel electrode 24α included in the array substrate 21 according to the present embodiment includes a first overlapping portion 40 overlapping at least a part of the first slit 30Aα, and the second pixel electrode 24β includes a second overlapping portion 41 overlapping at least a part of the remaining portion 30B. As illustrated in FIGS. 7 and 8, the first pixel electrode 24α including the first overlapping portion 40 is disposed to be aligned with the first slit 30Aα included in the first touch electrode 30α in the X-axis direction, but not to be aligned with the remaining portion 30B in the X-axis direction. The first overlapping portion 40 is formed by widening the contact portion 24B of the first pixel electrode 24α. That is, the first overlapping portion 40 is in a relationship of selectively overlapping a portion of the first slit 30Aα extending substantially along the Y-axis direction, the portion being aligned with the contact portion 24B of the first pixel electrode 24α in the X-axis direction. The first overlapping portion 40 overlaps the second region A2 located on the first TFT 23α side (right side in FIGS. 7 and 8) with respect to the first region A1 of the first slit 30Aα. That is, as illustrated in FIGS. 7 to 9, the first overlapping portion 40 is located so as to fill a space opened between the first touch wiring line 31α and the side edge of the first slit 30Aα in the X-axis direction. The first overlapping portion 40 does not overlap the first touch wiring line 31α (first source wiring line 27α). Although FIGS. 7 to 9 illustrate the configuration in which the first TFT 23α is disposed on the right side in FIGS. 7 to 9 with respect to the first source wiring line 27α, for example, as illustrated in FIGS. 2 and 3, when the first TFT 23α is disposed on the left side in FIGS. 2 and 3 with respect to the first source wiring line 27α, the first overlapping portion 40 overlaps a part of the second region A2 of the first slit 30Aα located on the first TFT 23α side (left side in FIGS. 1 and 2) with respect to the first region A1.

As illustrated in FIGS. 10 and 11, the second pixel electrode 24β including the second overlapping portion 41 is aligned with the remaining portion 30B included in the first touch electrode 30α in the X-axis direction. The second overlapping portion 41 is formed by widening the contact portion 24B of the second pixel electrode 24β. The second overlapping portion 41 is configured such that a formation range thereof in the Y-axis direction extends across the slit 30A and the remaining portion 30B. Specifically, the second overlapping portion 41 is disposed across a part of the slit 30A located on the upper side in FIGS. 10 and 11 among the two slits 30A sandwiching the remaining portion 30B and a part of the remaining portion 30B. The second overlapping portion 41 overlaps a portion of the remaining portion 30B on the second TFT 23β side (right side in FIGS. 10 and 11) in the X-axis direction. The second overlapping portion 41 overlaps a part of the second region A2 of the slit 30A located on the second TFT 23β side with respect to the first region A1. That is, as illustrated in FIGS. 10 to 12, the second overlapping portion 41 is located so as to fill a space opened between the first touch wiring line 31α and the side edge of the slit 30A in the X-axis direction. The second overlapping portion 41 does not overlap the first touch wiring line 31α (first source wiring line 27α). Although FIGS. 10 to 12 illustrate the configuration in which the second TFT 23β is disposed on the right side in FIGS. 7 to 9 with respect to the first source wiring line 27α, for example, as illustrated in FIGS. 2 and 3, when the second TFT 23β is disposed on the left side in FIGS. 2 and 3 with respect to the first source wiring line 27α, the second overlapping portion 41 overlaps a portion of the remaining portion 30B on the second TFT 23β side (right side in FIGS. 10 and 11) in the X-axis direction and a part of the second region A2 of the slit 30A located on the second TFT 23β side with respect to the first region A1.

In this manner, the first pixel electrode 24α includes the first overlapping portion 40 and the second pixel electrode 24β includes the second overlapping portion 41, and thus the electric field that may be generated between the first source wiring line 27α and the first touch electrode 30α can be blocked by the first overlapping portion 40 in the vicinity of the first slit 30Aα of the first touch electrode 30α and the electric field that may be generated between the first source wiring line 27α and the first touch electrode 30α can be blocked by the second overlapping portion 41 in the vicinity of the remaining portion 30B of the first touch electrode 30α. Accordingly, a difference is less likely to occur between the potential of the first pixel electrode 24α and the potential of the second pixel electrode 24β, and as a result, display unevenness is less likely to be visually recognized. In addition, even when the first slit 30Aα is formed wider than the first touch wiring line 31α to include the second region A2 in addition to the first region A1, the first overlapping portion 40 of the first pixel electrode 24α overlaps the second region A2. Thus, the electric field that may be generated between the first source wiring line 27α and the first touch electrode 30α can be satisfactorily shielded by the first overlapping portion 40.

As illustrated in FIG. 6, the first touch wiring line 31α is not connected to the first touch electrode 30α, but is connected to the second touch electrode 30β disposed at a position farther from the driver 11 than the first touch electrode 30α in the Y-axis direction. Thus, the first touch wiring line 31α crosses the first touch electrode 30α disposed at a position closer to the driver 11 than the second touch electrode 30β in the Y-axis direction. Thus, a parasitic capacitance is generated between the first touch wiring line 31α and the first touch electrode 30α that is not connected to the first touch wiring line 31α. In this regard, the first slit 30Aα and the second slit 30Aβ are provided in the first touch electrode 30α, and thus the parasitic capacitance generated between the first touch wiring line 31α and the first touch electrode 30α can be favorably reduced. In contrast, the first touch wiring line 31α and the second touch electrode 30β are connected to each other and have the same potential, and thus it is not necessary to provide the slit 30A in a portion of the second touch electrode 30β overlapping the first touch wiring line 31α.

On the other hand, as illustrated in FIG. 6, the second touch wiring line 31β is connected to the first touch electrode 30α disposed at a position closer to the driver 11 than the second touch electrode 30β in the Y-axis direction. In this manner, the second touch wiring line 31β is connected to the first touch electrode 30α, and thus the second touch wiring line 31β does not cross the second touch electrode 30β. Thus, the slit 30A overlapping the second touch wiring line 31β does not exist in the second touch electrode 30β. In this manner, the first touch electrode 30α and the second touch electrode 30β have different configurations due to a positional relationship with the driver 11, and thus a difference is likely to occur between the electric field that may be generated between the first source wiring line 27α and the first touch electrode 30α and the electric field that may be generated between the second source wiring line 27β and the second touch electrode 30β. In this regard, the first pixel electrode 24α and the second pixel electrode 24β overlapping the first touch electrode 30α have the first overlapping portion 40 and the second overlapping portion 41, respectively, and the electric field that may be generated between the first source wiring line 27α and the first touch electrode 30α is shielded. Thus, a difference that may be generated between the electric field that may be generated between the first source wiring line 27α and the first touch electrode 30α and the electric field that may be generated between the second source wiring line 27β and the second touch electrode 30β is mitigated. Accordingly, display unevenness is less likely to be visually recognized between the first touch electrode 30α and the second touch electrode 30β.

As described above, the array substrate (display substrate) 21 of the present embodiment includes the first source wiring line (first wiring line) 27α formed of the second metal film (first conductive film) and extending along the first direction, the first TFT 23 (first switching element) 23α connected to the first source wiring line 27α, the second TFT 23 (second switching element) 23β connected to the first source wiring line 27α, the first touch wiring line (second wiring line) 31α formed of the third metal film (second conductive film) disposed on the upper layer side of the second metal film via the first interlayer insulating film 35 as the first insulating film and the flattening film 36, extending along the first direction, and overlapping the first source wiring line 27α, the first pixel electrode (first electrode) 24α formed of the first transparent electrode film (third conductive film) disposed on the upper layer side of the third metal film via the second interlayer insulating film (second insulating film) 37 and connected to the first TFT 23α, the second pixel electrode (second electrode) 24β formed of a portion of the first transparent electrode film different from the first pixel electrode 24α and connected to the second TFT 23β, and the first touch electrode (third electrode) 30α formed of the second transparent electrode film (fourth conductive film) disposed on the upper layer side of the first transparent electrode film via the third interlayer insulating film (third insulating film) 38, and overlapping the first pixel electrode 24α and the second pixel electrode 24β, in which the first touch electrode 30α includes the first slit 30Aα extending along the first direction and overlapping a part of the first touch wiring line 31α, the second slit 30Aβ extending along the first direction, overlapping a part of the first touch wiring line 31α, and disposed spaced apart in the first direction with respect to the first slit 30Aα, and the remaining portion 30B overlapping a part of the first touch wiring line 31α and remaining between the first slit 30Aα and the second slit 30Aβ in the first direction, the first pixel electrode 24α includes the first overlapping portion 40 that is disposed side by side with respect to the first slit 30Aα in the second direction intersecting the first direction but is not disposed side by side with respect to the remaining portion 30B in the second direction, and overlaps at least a part of the first slit 30Aα, and the second pixel electrode 24β includes the second overlapping portion 41 that is disposed side by side with respect to the remaining portion 30B in the second direction and overlaps at least a part of the remaining portion 30B.

A signal transmitted by the first source wiring line 27α is supplied to the first pixel electrode 24α at a timing at which the first TFT 23α is driven, and is supplied to the second pixel electrode 24β at a timing at which the second TFT 23β is driven. An electric field corresponding to a potential difference is generated between the first and the second pixel electrodes 24α and 24β and the first touch electrode 30α overlapping each other via the third interlayer insulating film 38, and thus it is possible to display an image using the electric field. The first touch electrode 30α is provided with the first slit 30Aα and the second slit 30Aβ extending along the first direction and overlapping a part of the first touch wiring line 31α. Thus, the parasitic capacitance generated between the first touch wiring line 31α composed of the third metal film and the first touch electrode 30α composed of the second transparent electrode film can be reduced. The first touch electrode 30α includes the remaining portion 30B remaining between the first slit 30Aα and the second slit 30Aβ in the first direction, and thus the first touch electrode 30α is prevented from being divided into a plurality of portions by the first slit 30Aα and the second slit 30Aβ.

On the other hand, in the vicinity of the first slit 30Aα and the second slit 30Aβ in the first touch electrode 30α, the electric field generated between the first source wiring line 27α and the first touch electrode 30α is relatively weak, whereas in the vicinity of the remaining portion 30B in the first touch electrode 30α, the electric field generated between the first source wiring line 27α and the first touch electrode 30α tends to be relatively strong. Thus, a difference may occur between a potential of the first pixel electrode 24α charged based on a signal supplied from the first source wiring line 27α to the first pixel electrode 24α via the first TFT 23α and a potential of the second pixel electrode 24β charged based on a signal supplied from the first source wiring line 27α to the second pixel electrode 24β via the second TFT 23β. In this regard, the first pixel electrode 24α aligned with the first slit 30Aα in the second direction but not aligned with the remaining portion 30B in the second direction includes the first overlapping portion 40 overlapping at least a part of the first slit 30Aα, and the second pixel electrode 24β aligned with the remaining portion 30B in the second direction includes the second overlapping portion 41 overlapping at least a part of the remaining portion 30B. Thus, the electric field that is generated between the first source wiring line 27α and the first touch electrode 30α can be blocked by the first overlapping portion 40 in the vicinity of the first slit 30Aα of the first touch electrode 30α and the electric field that is generated between the first source wiring line 27α and the first touch electrode 30α can be blocked by the second overlapping portion 41 in the vicinity of the remaining portion 30B of the first touch electrode 30α. Accordingly, a difference is less likely to occur between the potential of the first pixel electrode 24α and the potential of the second pixel electrode 24β, and as a result, display unevenness is less likely to be visually recognized.

The first touch electrode 30α is formed wider than the first touch wiring line 31α so that the first slit 30Aα includes the first region A1 which overlaps the first touch wiring line 31α and the second region A2 which does not overlap the first touch wiring line 31α, and the first overlapping portion 40 is disposed so as to overlap at least the second region A2 of the first slit 30Aα. When the first slit 30Aα is formed wider than the first touch wiring line 31α so as to include the second region A2 in addition to the first region A1, the parasitic capacitance generated between the first touch wiring line 31α and the first touch electrode 30α can be further reduced. In this manner, even when the first slit 30Aα is configured to include the second region A2 in addition to the first region A1, the first overlapping portion 40 of the first pixel electrode 24α overlaps the second region A2. Thus, the electric field that may be generated between the first source wiring line 27α and the first touch electrode 30α can be satisfactorily shielded by the first overlapping portion 40.

In addition, the array substrate 21 includes the third TFT 23 (third switching element) connected to the first source wiring line 27α, the third pixel electrode (fourth electrode) 24γ formed of a portion of the first transparent electrode film different from the first pixel electrode 24α and the second pixel electrode 24β and connected to the third TFT 23γ, and the second touch electrode (fifth electrode) 30β formed of a portion of the second transparent electrode film different from the first touch electrode 30α and overlaps the third pixel electrodes 24γ, and the first touch wiring line 31α is connected to the second touch electrode 30β. A signal transmitted by the first touch wiring line 31α is supplied to the second touch electrode 30β. Although parasitic capacitance is generated between the first touch wiring line 31α and the first touch electrode 30α that is not connected to the first touch wiring line 31α, the first slit 30Aα and the second slit 30Aβ are provided in the first touch electrode 30α, and thus the parasitic capacitance can be favorably reduced.

In addition, the array substrate 21 includes the second source wiring line (third wiring line) 27β formed of a portion of the second metal film different from the first source wiring line 27α and extending along the first direction, the second touch wiring line (fourth wiring line) 31β formed of a portion of the third metal film different from the first touch wiring line 31α, extending along the first direction, and overlapping the second source wiring line 27β, and the driver (signal supply unit) 11 connected to one end portion of each of the first source wiring line 27α and the second source wiring line 27β and supplying a signal to each of the first source wiring line 27α and the second source wiring line 27β, in which the second touch electrode 30β is disposed at a position farther from the driver 11 than the first touch electrode 30α in the first direction, and the second touch wiring line 31β is connected to the first touch electrode 30α. The first touch wiring line 31α is connected to the second touch electrode 30β disposed at a position farther from the driver 11 than the first touch electrode 30α in the first direction, and thus the first touch wiring line 31α crosses the first touch electrode 30α. Although the first touch wiring line 31α and the first touch electrode 30α are not connected to each other, the first touch electrode 30α is provided with the first slit 30Aα and the second slit 30Aβ overlapping the first touch wiring line 31α, and thus the parasitic capacitance generated between the first touch wiring line 31α and the first touch electrode 30α is reduced. In contrast, the first touch wiring line 31α and the second touch electrode 30β are connected to each other and have the same potential, and thus it is not necessary to provide the slit 30A in a portion of the second touch electrode 30β overlapping the first touch wiring line 31α. On the other hand, the second touch wiring line 31β is connected to the first touch electrode 30α disposed at a position closer to the driver 11 than the second touch electrode 30β in the first direction, and thus the second touch wiring line 31β does not cross the second touch electrode 30β. Thus, the slit 30A overlapping the second touch wiring line 31β does not exist in the second touch electrode 30β. In this manner, the first touch electrode 30α and the second touch electrode 30β have different configurations due to a positional relationship with the driver 11, and thus a difference is likely to occur between the electric field that may be generated between the first source wiring line 27α and the first touch electrode 30α and the electric field that may be generated between the second source wiring line 27β and the second touch electrode 30β. In this regard, the first pixel electrode 24α and the second pixel electrode 24β overlapping the first touch electrode 30α have the first overlapping portion 40 and the second overlapping portion 41, respectively, and the electric field that may be generated between the first source wiring line 27α and the first touch electrode 30α is shielded. Thus, a difference that may be generated between the electric field that may be generated between the first source wiring line 27α and the first touch electrode 30α and the electric field that may be generated between the second source wiring line 27β and the second touch electrode 30β is mitigated. Accordingly, display unevenness is less likely to be visually recognized between the first touch electrode 30α and the second touch electrode 30β.

Further, the liquid crystal panel (display device) 10 according to the present embodiment includes the above-described array substrate 21 and the counter substrate 20 facing the array substrate 21 spaced apart. According to the liquid crystal panel 10 having such a configuration, display unevenness is less likely to be visually recognized.

### OTHER EMBODIMENTS

The techniques disclosed herein are not limited to the embodiments described above and illustrated in the drawings, and the following embodiments, for example, are also included within the technical scope.

(1) The touch electrode 30 may be configured such that the width of the slit 30A changes depending on a position in the Y-axis direction. For example, the width of the slit 30A in the vicinity of the TFT 23 may be wider than the width in the vicinity of the pixel electrode main body 24A. When the width of the slit 30A is changed depending on the position in the Y-axis direction, the second region A2 of the slit 30A may partially not be formed depending on the position in the Y-axis direction.

(2) The touch electrode 30 may be configured such that the slit 30A includes one first region A1 and one second region A2. That is, the slits 30A may be unevenly distributed on one side in the X-axis direction with respect to the touch wiring line 31.

(3) The specific arrangement of the touch wiring line 31 and the dummy wiring line 32 with respect to the touch electrode 30 can be appropriately changed other than those illustrated in the drawings. For example, the touch wiring lines 31 may be unevenly distributed on one side of the touch electrode 30 in the X-axis direction, and the dummy wiring lines 32 may be unevenly distributed on the other side of the touch electrode 30 in the X-axis direction.

(4) One touch wiring line 31 may be connected to one touch electrode 30, and three or more touch wiring lines 31 may be connected to one touch electrode 30.

(5) The source wiring line 27 and the touch wiring line 31 may not have the same width.

(6) Specific number of installation, shape, formation range, and the like of the pixel slit 25B included in the common electrode 25 can be appropriately changed other than those illustrated in the drawings.

(7) The plurality of TFTs 23 may be an array in which the TFTs 23 disposed on one side in the X-axis direction of the source wiring line 27 to be connected thereto, and the TFTs 23 disposed on the other side in the X-axis direction of the source wiring line 27 to be connected thereto are alternately arranged in the Y-axis direction. Further, all of the TFTs 23 may be disposed on one side or the other side in the X-axis direction of the source wiring line 27 to be connected thereto.

(8) The patterns of the gate wiring line 26 and the source wiring line 27 (the touch wiring line 31 and the dummy wiring line 32) in a plan view can be changed as appropriate. For example, the gate wiring line 26 may extend obliquely to be repeatedly bent in the middle without extending linearly. Further, the source wiring line 27 may extend linearly in the Y-axis direction. Further, the gate wiring line 26 and the source wiring line 27 may all extend obliquely to be repeatedly bent in the middle without extending linearly. Further, the gate wiring line 26, and the source wiring line 27 may all extend linearly.

(9) The gate circuit portion 13 may be omitted. In this case, a gate driver having the same function as that of the gate circuit portion 13 may be mounted on the array substrate 21. Further, it is also possible to provide the gate circuit portion 13 to only one side portion on one side of the array substrate 21.

(10) The material of the semiconductor film constituting the semiconductor portion 23D may be polysilicon (low-temperature polycrystalline silicon (LTPS)) or the like.

(11) The touch panel pattern may be a mutual-capacitance type in addition to a self-capacitance type.

(12) The configurations of the TFT 23 may be a top gate type, a double gate type, or the like, in addition to the bottom gate type illustrated in the drawings.

(13) The planar shape of the liquid crystal panel 10 may be rectangular with longitudinal elongation, square, circular, semi-circular, elliptical, oval, trapezoidal, or the like.

(14) The liquid crystal panel 10 may be a reflective type or a semi-transmissive type, in addition to a transmissive type.

(15) The display panel may be a type different from the liquid crystal panel 10 (such as an organic electroluminescence (EL) display panel) or a microcapsule-type electrophoretic display panel (EPD).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display substrate comprising:
a first wiring line formed of a first conductive film and extending along a first direction;
a first switching element connected to the first wiring line;
a second switching element connected to the first wiring line;
a second wiring line formed of a second conductive film disposed on an upper layer side of the first conductive film via a first insulating film, extending along the first direction, and overlapping the first wiring line;
a first electrode formed of a third conductive film disposed on an upper layer side of the second conductive film via a second insulating film and connected to the first switching element;
a second electrode formed of a portion of the third conductive film different from the first electrode and connected to the second switching element; and
a third electrode formed of a fourth conductive film disposed on an upper layer side of the third conductive film via a third insulating film and overlapping the first electrode and the second electrode,
wherein the third electrode includes
a first slit extending along the first direction and overlapping a part of the second wiring line,
a second slit extending along the first direction, overlapping a part of the second wiring line, and disposed spaced apart in the first direction with respect to the first slit, and
a remaining portion overlapping a part of the second wiring line and remaining between the first slit and the second slit in the first direction,
the first electrode includes a first overlapping portion that is disposed side by side with respect to the first slit in a second direction intersecting the first direction but is not disposed side by side with respect to the remaining portion in the second direction, and overlaps at least a part of the first slit, and
the second electrode includes a second overlapping portion that is disposed side by side with respect to the remaining portion in the second direction and overlaps at least a part of the remaining portion.

2. The display substrate according to claim 1,
wherein the third electrode is formed wider than the second wiring line and the first slit includes a first region overlapping the second wiring line and a second region not overlapping the second wiring line, and
the first overlapping portion overlaps at least the second region of the first slit.

3. The display substrate according to claim 1, further comprising:
a third switching element connected to the first wiring line;
a fourth electrode formed of a portion of the third conductive film different from the first electrode and the second electrode, and connected to the third switching element; and
a fifth electrode formed of a portion of the fourth conductive film different from the third electrode, and overlapping the fourth electrode,
wherein the second wiring line is connected to the fifth electrode.

4. The display substrate according to claim 3, further comprising:
a third wiring line formed of a portion of the first conductive film different from the first wiring line, and extending along the first direction;
a fourth wiring line formed of a portion of the second conductive film different from the second wiring line, extending along the first direction, and overlapping the third wiring line; and
a signal supply unit connected to one end portion of each of the first wiring line and the third wiring line and configured to supply a signal to each of the first wiring line and the third wiring line,
wherein the fifth electrode is disposed at a position farther from the signal supply unit than the third electrode in the first direction, and
the fourth wiring line is connected to the third electrode.

5. A display device comprising:
the display substrate according to claim 1; and
a counter substrate disposed to face the display substrate and spaced apart from the display substrate.
